(19) United States
(12) Patent Application Publication
(10) Pub. No.: US 2019/0293120 A1
(43) Pub. Date: Sep. 26, 2019

(54) LEAD-FREE ALUMINIUM SLIDING BEARING MATERIAL HAVING A FUNCTIONAL SURFACE

(71) Applicant: FEDERAL-MOGUL WIESBADEN GMBH, WIESBADEN (DE)

(72) Inventors: HOLGER SCHMITT, PFUNGSTADT (DE); DANIEL MEISTER, MAINZ (DE); MICHAEL WAGNER, WIESBADEN (DE); GAETANO FABIO COSENTINO, WIESBADEN (DE); RALPH HERBER, IDSTEIN (DE); STEFANIE KATHARINA WEIDMANN, MAINZ (DE)

(21) Appl. No.: 16/318,465

(22) PCT Filed: Jun. 29, 2017
(86) PCT No.: PCT/EP2017/066147

§ 371 Date: Jan. 17, 2019

(30) Foreign Application Priority Data
Jul. 21, 2016 (DE) 10 2016 213 352.7

(51) Int. Cl. F16C 33/12; F16C 33/10; B32B 15/01

(52) U.S. Cl. CPC F16C 33/122; B32B 2307/302; F16C 33/1095; B32B 15/012; F16C 2204/22; F16C 2202/04; F16C 2202/20; F16C 2206/44; F16C 2223/70; F16C 2240/64; B32B 2264/102; B32B 2264/108; B32B 2264/104; B32B 2311/24; B32B 2311/30; B32B 2475/00; B32B 2307/536; F16C 33/121

(57) ABSTRACT

The invention relates to a sliding element having a coating, which comprises at least one functional layer, said functional layer having a mixed oxide-matrix and in the mixed-oxide matrix and solid lubricant particles and/or hard particles are embedded in the mixed oxide-matrix.

### BACKGROUND

### 1. Technical Field

The present invention relates lo a sliding element having a mixed oxide matrix functional layer. A sliding element according lo the invention is characterised by advantageous surface properties and is easy to make.

### 2. Related Art

The use of oxide layers as a constituent of sliding bearing coatings is well known in the prior art.

DE 10 2007 042 382 B3 discloses a component which is suitable as a sliding bearing, wherein a layer made of a light metal material is provided in the structure of the component, which material is provided with an oxide layer having pores in the direction of the sliding surface of the component, and wherein a hard material is introduced into said pores.

DE 196 12 109 C1 relates to a bearing component with a surface that can be subjected to tribological stress. For this purpose, it is provided that the bearing component consists of a metal matrix composite material whose matrix is formed by an aluminium alloy reinforced with SiC particles in a proportion of more than 1% by weight, and that the tribologically stressable surface is the surface of an anodisation layer.

The final Report of the IGF Project 302 ZBG “Nanopartikelverstärkie Hartanodisierschichten als innovativer Verschleiβ-und Korrosionsschulz für Aluminiumwerkstoffe” by Fürbeth et al. deals with the introduction of nanoparticles into hard anodised layers of aluminium materials. Finally, the Final Report of the IGF Project 321 ZBG “Optimierung der Modifizierung von Anodisierschichten auf Aluminiumwerkstoffen durch chemische Nanotechnologie und industrielle Anpassung des Verfahrens” by Fürbeth et al. teaches the impregnation of anodiscd layers with nanoparticles to improve corrosion protection.

### SUMMARY OF THE INVENTION

An object of the invention is to provide a sliding element with improved surface properties, especially with regard to at least one of the properties: hardness, ductility, thermal conductivity, wetting behaviour, friction coefficient, wear behaviour, roughness and/or topography.

The embedding of solid lubricant particles and/or hard particles in the mixed oxide matrix of the functional layer of the sliding element coaling leads to particularly advantageous mechanical properties of the sliding element. In particular, the property profile of the sliding element can be specifically tailored to the respective application by targeted selection of the solid lubricant panicles and/or hard particles. Compared to the use of pores in the oxide coatings of sliding bearings as a reservoir for lubricant, the advantage of a more homogeneous distribution and greater flexibility with regard to the panicles to be used is also obtained.

According to the invention, the coating comprises, from the inside to the outside, at least one aluminium alloy layer consisting of an aluminium-based alloy, and the functional layer. Such a structure can be produced in a particularly simple manner by electrolytic oxidation of the aluminium alloy layer. The terms “aluminium alloy layer” and “aluminium-based alloy” also encompass pure aluminium and pure aluminium layers.

According to the invention, the solid lubricant particles comprise BaSO₄, h-BN, graphite, MoS₂, PTFE, WS₂, ZnS and/or SnS₂. The aforementioned particles are particularly suitable for improving the lubricating properties of the sliding element surface.

According to the invention, the hard particles comprise oxides, nitrides, phosphides, phosphates, fluorides, WC, TiC, TaC, CrC, B₄C, CaC₂ and/or Al₄C₃ in order to increase wear resistance.

Preferably, the aluminium-based alloy consists of up to 10.0 wt % Fe, up to 10.0 wt % Mg, up to 15.0 wt % Zn, up to 15.0 wt % Si, up to 30.0 wt % Sn, up to 5.0 wt % Cu, up to 5.0 wt % Ni, up to 5.0 wt % Mn, up to 5.0 wt % Cr, up to 1.0 wt % Zr, V, Sr and/or Ti, the remainder being aluminium and unavoidable impurities. The aforementioned chemical composition of the aluminium-based alloy makes it possible to obtain a sliding element metal hardness of between 30 and 100 HBW 1/5/30.

Most preferably, the functional layer is applied onto the aluminium alloy layer. The aluminium alloy layer is in turn preferably applied onto a substrate backing consisting of steel, preferably one of the steel grades C06-C45. The aforementioned steels are characterised by good availability and bond particularly well to the aluminium alioy layer to form a sliding element.

In addition, an intermediate layer preferably consisting of pure aluminium is to be introduced between the substrate backing and the aluminium alloy layer. The intermediate layer improves the bond between the substrate backing and the coating.

Furthermore, provision is made to embed organically modified particles, particles with sinter additives such as preferably NaHCO₃, core-shell particles, nanocapsules which are preferably filled with solid lubricant, and/or panicles embedded in a polymeric sol in the mixed oxide matrix. These lead to a particularly homogeneous distribution of the particles in the mixed oxide matrix.

The coating advantageously comprises, from the inside to the outside, at least one aluminium alioy layer consisting of an aluminium-based alloy, and the functional layer. Such a structure can be produced in a particularly simple manner by electrolytic oxidation of the aluminium alloy layer. The terms “aluminium alloy layer” and “aluminium-based alloy” also encompass pure aluminium and pure aluminium layers.

Preferably, the aluminium-based alloy consists of up to 10.0 wt % Fe, up to 10.0 wt % Mg, up to 15.0 wt % Zn, up to 15.0 wt % Si, up to 30.0 wt % Sn, up to 5.0 wt % Cu, up to 5.0 wt % Ni, up to 5.0 wt % Mn, up to 5.0 wt % Cr, up to 1.0 wt % Zr, V, Sr and/or Ti, the remainder being aluminium and unavoidable impurities. The aforementioned chemical composition of the aluminium-based alloy makes it possible to obtain a sliding element metal hardness of between 30 and 100 HBW 1/5/30.

Most preferably, the functional layer is applied onto the aluminium alloy layer. The aluminium alloy layer is in turn preferably applied onto a substrate backing consisting of steel, preferably one of the steel grades C06-C45. The aforementioned steels are characterised by good availability and bond particularly well to the aluminium alloy layer to form a sliding element.

In addition, an intermediate layer preferably consisting of pure aluminium is to be introduced between the substrate backing and the aluminium alloy layer. The intermediate layer improves the bond between the substrate backing and the coaling.

The solid lubricant particles advantageously comprise BaSO₄, h-BN, graphite, MoS₂, PTFE, WS₂, ZnS and/or SnS₂. The aforementioned particles are particularly suitable for improving the lubricating properties of the sliding element surface.

The hard particles preferably comprise oxides, nitrides, phosphides, phosphates, fluorides, WC, TiC, TaC, CrC, B₄C, CaC₂ and/or Al₄C₃ in order to increase wear resistance.

Furthermore, provision is made to embed organically modified particles, particles with sinter additives such as preferably NaHCO₃, core-shell particles, nanocapsules which are preferably filled with solid lubricant, and/or particles embedded in a polymeric sol in the mixed oxide matrix. These lead lo a particularly homogeneous distribution of the particles in the mixed oxide matrix.

The coating advantageously has a hardness of 10 to 1500 HV, preferably 10-500 HV0.1. Layers that are too soft yield under load and lead to seizing due to material transfer, and reduce the effect of the hard particles and solid lubricant, in contrast, layers that arc too hard may affect the counter-member of the sliding element due to abrasion. The functional layer is furthermore preferably between 10 nm and 100 μm thick. If the layer thickness is of less than 10 nm. there is no sufficient improvement in the wear protection, whereas layers with thicknesses of more than 100 μm can only be produced at great financial cost.

The aluminium alloy layer preferably has a thickness of up to 500 μm. Greater layer thicknesses do not result in further improvement in the mechanical properties of the sliding element.

To improve the functional layer properties, the embedded particles preferably have an average diameter of 1 nm to 15 μm.

The functional layer advantageously has a thermal conductivity of 5 to 100 W/m*k, preferably 20 to 40 W/m*k. These values lie at the level of pure aluminium oxide, so that good heat dissipation is achieved under mixed friction conditions.

In addition, it is provided according to the invention that the distribution of the solid lubricant particles and/or hard particles in the mixed oxide matrix has a gradient from the inside to the outside. Thus, other structures can be set in the surface region of the coating than in the inner region without weakening the adhesion by discontinuities.

Finally, the coating preferably has on its outside a cover layer which is preferably applied electrolytically. Such a cover layer can increase the wear resistance and or improve the friction properties, depending on the application.

### DETAILED DESCRIPTION

According to a preferred embodiment, there is provided a sliding bearing with a coating on a C06 steel substrate backing. The following layer structure is particularly preferred: a so-called aluminium alloy layer with the elements mentioned in claim 3 is located on the steel backing. The functional layer is then produced by chemical-physical processes (anodisation) and can in turn contain solid lubricant particles and/or hard particles. In this case, an aluminium alloy is first cast by means of strip casting and then roiled down to a thickness of maximum 1.5 mm by the subsequent rolling steps. When an intermediate film is used for improving the adhesion, the strip and the film are then joined to form a strand by means of roll-cladding. Subsequently, the strand is ground and applied onto the C06 steel by roll-cladding. The sliding bearing material subsequently obtains bearing shell dimensions by means of conventional shaping steps. The mixed oxide matrix is subsequently produced galvanostatically or potentiostatically by electrolytic oxidation of the aluminium alloy layer using direct current, alternating current or pulsed current sources. The methodology required for this purpose is known to the skilled person from the prior art, for example from the final Report of the IGF Project 321 ZBG (“Optimierung der Modifizierung von Anodisierschichten auf Aluminiumwerkstoffen durch chemische Nanotechnologie und industrielle Anpassung des Verfahrens”; Fürbeth et al.; chapter 2.5). At the same time, B₄C particles are deposited in parallel by means of electrophoretic deposition and are thereby embedded in the mixed oxide matrix. To ensure homogeneous particle distribution, an agglomeration of the particles is ensured by using stabilised dispersions, finally, the sliding bearing surfaces are aftertreated.

1. A sliding element with 3 coating comprising at least one functional layer, characterised in that the functional layer comprises a mixed oxide matrix, and solid lubricant particles and/or hard particles are embedded in the mixed oxide matrix.

2. The sliding element according to claim 1, characterised in that the coating comprises at least the following layers from the inside to the outside:
an aluminum alloy layer consisting of an aluminium-based alloy, and the functional layer.

3. The sliding element according to claim 1 or 2, characterised in that the aluminium-based alloy consists of
up to 10.0 wt % Fe,
up to 10.0 wt % Mg,
up to 15.0 wt % Zn,
up to 15.0 wt % Si,
up to 30.0 wt % Sn,
up to 5.0 wt % Cu,
up to 5.0 wt % Ni,
up to 5.0 wt % Mn,
up to 5.0 wt % Cr,
up to 1.0 wt % Zr, V, Sr and/or Ti and the remainder is aluminium and unavoidable impurities.

4. The sliding element according to one of the preceding claims, characterised in that
the functional layer is applied onto the aluminium alloy layer which is in turn bonded to a substrate backing, and the substrate backing consists of steel, preferably one of the steel grades C06-C45.

5. The sliding element according to claim 4, characterised in that
an intermediate layer preferably consisting of pure aluminium is provided between the substrate backing and the coating.

6. The sliding element according to one of the preceding claims, characterised in that
the solid lubricant particles comprise BaSO₄, h-BN, graphite, MoS₂, PTFE, WS₂, ZnS and/or SnS₂.

7. The sliding element according to one of the preceding claims, characterised in that
the hard particles comprise oxides, nitrides, phosphides, phosphates, fluorides, WC, TiC, TaC, CrC, B₄C, CaC₂ and/or Al₄C₃.

8. The sliding element according to one of the preceding claims, characterised in that
organically modified particles, particles with sinter additives such as preferably N₃HCO₃, core-shell particles, nanocapsules which are preferably filled with solid lubricant, and/or particles embedded in a polymeric sol are embedded in the mixed oxide matrix.

9. The sliding element according to one of the preceding claims, characterised in that
the coating has a hardness of 10 to 1500 HV0.1, preferably 10-500 HV0.1.

10. The sliding element according to one of the preceding claims, characterised in that
the functional layer has a thickness of 10 nm to 100 μm.

11. The sliding element according to one of claims 2 to 10, characterised in that
the aluminium alloy layer has a thickness of up to 200 μm.

12. The sliding element according to one of the preceding claims, characterised in that
the embedded particles have an average diameter of 1 nm to 15 μm.

13. The sliding element according to one of the preceding claims, characterised in that
the functional layer has a thermal conductivity of 5 to 100 W/m*k, preferably 20 to 40 W/m*k.

14. The sliding element according to one of the preceding ciaims, characterised in that
the distribution of the solid lubricant particles and/or hard particles in the mixed oxide matrix has a gradient from the inside to the outside.

15. The sliding element according to one of the preceding claims, characterised in that
the coating has on its outside a cover layer which is preferably applied electrolytically.
